(19) United States
(12) Patent Application Publication
(10) Pub. No.: US 2025/0181824 A1
(43) Pub. Date: Jun. 5, 2025

(54) MODIFYING SUBPORTIONS OF LARGE LANGUAGE MODEL OUTPUTS

(71) Applicant: GOOGLE LLC, Mountain View, CA (US)

(72) Inventors: Jacint Szabo, Zurich (CH); Padmanabh Pande, Zurich (CH); Gabriel Rovina, Zurich (CH); Mariia Kliuieva, Zurich (CH); Kyle Gerard, Zurich (CH); Vojta Letal, Zurich (CH)

(21) Appl. No.: 18/525,505

(22) Filed: Nov. 30, 2023

(51) Int. Cl. G06F 40/166; G06F 3/04842; G06F 16/93; G06F 40/197

(52) U.S. Cl. CPC G06F 40/166; G06F 16/93; G06F 40/197; G06F 3/04842

(57) ABSTRACT

Implementations are described herein for using LLMs to modify less than the entirety of rendered LLM outputs. In various implementations, a first LLM response is used by a client application to provide first rendered LLM output. The client application may provide (i) an indication of a subportion of the first rendered LLM output that is selected by a user, and (ii) a request to modify the selected subportion. A subportion of the first LLM response corresponding to the selected subportion of the first rendered LLM output may be used to assemble a second LLM prompt, which may be processed using one or more LLMs to generate a second LLM response. The second LLM response may be operable to provide second rendered LLM output that includes at least part of the first rendered LLM output outside of the selected subportion and the modified selected subportion.

Large language models (LLMs) can be used to process, as LLM input, sequences of input tokens to generate, as LLM responses, sequences of output tokens. These sequences of input/output tokens often take the form of strings of text, although they can take other forms such as embeddings, numbers, etc. Some LLM responses may include a relatively large number of details and/or extensive natural language. For example, a user may request that the LLM be used to generate a multi-paragraph summary of a document, a detailed invitation to a birthday party, a business email, etc.

### SUMMARY

If a user is dissatisfied with a rendered LLM output, they can copy the LLM output into a text editor and then modify the text manually. Alternatively, the user may issue a follow up natural language request to modify the entire LLM output, e.g., to add more detail, change the LLM output's “tone,” replace tokens with other tokens (e.g., synonyms), etc. However, it may be the case that the user is satisfied with some parts of the LLM output but not with others.

Implementations are described herein for using LLMs to modify selected subportions i.e., less than the entirety—of rendered LLM outputs. More particularly, but not exclusively, implementations are described herein for determining which subportion(s) of rendered LLM outputs have been selected by a user, and modifying those selected subportion(s) based on a request from the user to generate modified version(s) of those selected subportion(s) of the rendered LLM outputs. A user may select a subportion of a rendered LLM output in various ways, such as highlighting content (text and/or images) using a pointer device, touchscreen, and/or keyboard, verbally identifying a particular portion (e.g., “shorten the second paragraph,” “update the map to give driving directions instead of subway directions”), and so forth. In some implementations, the rendered LLM output may also be provided within an editable text field or other similar interface. This may allow the user to edit the rendered LLM output directly, instead of requiring the user to copy and paste the rendered LLM output into a text editor, word processor, or other application that allows the user to edit content.

Techniques described herein give rise to various technical advantages. A user who wishes to modify one part (e.g., a sentence, paragraph) of an LLM output (e.g., a business email, an invitation, advertising copy, etc.) but to leave another part of the LLM output untouched is no longer required to copy the entire LLM output to a separate content editing application. Instead, the user can provide the specific subportion of the LLM output they wish to edit as input to the LLM (or another LLM), along with their modification request. A subsequent LLM prompt that includes the user's modification request and selected subportion of the LLM output will be shorter than a subsequent LLM prompt that includes the entire LLM output and the user's modification request. Consequently, considerably less computational resources (e.g., processor cycles, memory) may be consumed, especially considering that LLMs often have hundreds of billions of parameters, which means longer input sequences take considerably longer to process.

Techniques described herein also enable the user to modify one modality of the LLM output while leaving another modality unchanged. Suppose a user requests that the LLM generate a multimodal document that includes both text and image(s). If the user only wishes to modify (e.g., replace, alter) the image(s) but not the text, the user may select the image(s) and issue a command to modify those selected image(s) accordingly. This may trigger application of a text-to-image generative model (e.g., a diffusion model or similar) to the user's request and selected image(s), rather than reinvoking the LLM that was used to generate the original multimodal LLM output. Alternatively, the system can search an image repository for replacement images, which may not necessarily require additional LLM processing.

In some implementations, a method may be implemented by one or more processors and may include: processing a first large language model (LLM) prompt using an LLM to generate a first LLM response; providing the first LLM response to a client application, wherein the first LLM response is operable by the client application to provide first rendered LLM output; receiving, from the client application: an indication of a subportion of the first rendered LLM output that has been selected using one or more input devices, and a request for a modified version of the selected subportion of the first rendered LLM output; extracting a subportion of the first LLM response that corresponds to the selected subportion of the first rendered LLM output; assembling, as a second LLM prompt, the selected subportion of the first LLM response with data indicative of the request to modify the selected subportion of the first rendered LLM output; processing the second LLM prompt using the same LLM or a different LLM to generate a second LLM response; and providing the second LLM response to the client application, wherein the second LLM response is operable by the client application to provide second rendered LLM output that includes at least a part of the first rendered LLM output outside of the selected subportion of the first rendered LLM output and the modified version of the selected subportion of the first rendered LLM output.

In various implementations, the first LLM response may include a string of raw text that includes “metadata instructions” for formatting the first rendered LLM output at the client. In various implementations, the selecting may include receiving, from the client application, a starting character position and an ending character position that identify a segment of the string of raw text outside of the metadata instructions. In various implementations, the request for a modified version of the selected subportion of the first rendered LLM output may include a request to add one or more details to the selected subportion of the first rendered LLM output. In various implementations, the request for a modified version of the selected subportion of the first rendered LLM output may include a request to modify or replace one or more details of the selected subportion of the first rendered LLM output.

In various implementations, the request for a modified version of the selected subportion of the first rendered LLM output may include a request to add content to the selected subportion of the first rendered LLM output that supports one or more details of the selected subportion of the first rendered LLM output. In various implementations, the method may include: formulating a search query based on the one or more details of the selected subportion of the first rendered LLM output; retrieving, from a search engine, one or more documents that are responsive to the search query; and incorporating data from the one or more documents that are responsive to the search query into the second LLM prompt.

In various implementations, the request for a modified version of the selected subportion of the first rendered LLM output may include a natural language request. In various implementations, the first LLM response may include metadata instructions for rendering one or more images, and the selected subportion of the first rendered LLM output comprises one or more rendered images. In various implementations, the request for a modified version of the selected subportion of the first rendered LLM output may include a request to replace one or more of the rendered images with one or more alternative images.

In various implementations, the request to replace one or more of the rendered images with one or more alternative images may include a natural language request to retrieve one or more replacement images having specified visual features.

In various implementations, the request for a modified version of the selected subportion of the first rendered LLM output may include a natural language request to generate a modified version of one or more of the rendered images, and processing the second LLM prompt using the same LLM or a different LLM may include processing the natural language request using a visual LLM to generate the modified version of one or more of the rendered images.

In addition, some implementations include one or more processors of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods. It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 schematically depicts an example of how various components described herein may cooperate to perform selected aspects of the present disclosure.

FIG. 3A, FIG. 3B, FIG. 3C, FIG. 3D, and FIG. 3E schematically depict examples of a graphical user interface (GUI) being used in accordance with various implementations described herein.

FIG. 4 depicts a flowchart illustrating an example method of practicing selected aspects of the present disclosure.

FIG. 5 depicts an example architecture of a computing device, in accordance with various implementations.

### DETAILED DESCRIPTION

Implementations are described herein for using LLMs to modify selected subportions—i.e., less than the entirety—of LLM outputs. More particularly, but not exclusively, implementations are described herein for determining which subportion(s) of LLM outputs have been selected by a user, and modifying those selected subportion(s) based on a request from the user to generate modified versions of those selected subportion(s) of the LLM output. A user may select a subportion of an LLM output in various ways, such as highlighting content (text and/or images) using a pointer device, touchscreen, and/or keyboard, verbally identifying a particular portion (e.g., “shorten the second paragraph,” “update the map to give driving directions instead of subway directions”), and so forth.

In various implementations, when a user issues a natural language query, that query may be used to assemble an LLM prompt that is then processed using an LLM to generate an LLM response. In various implementations, the LLM response may include a sequence of tokens that includes raw or plain text. This raw or plain text may include both responsive content and “metadata instructions” for formatting and/or otherwise rendering the responsive content. Metadata instructions may include, for instance, markup language (e.g., markdown, Latex, XML, HTML, etc.) symbols that set forth how text should be rendered (e.g., font, spacing) and/or how other content should be presented. For instance, some LLMs may generate LLM output that includes metadata instructions for rendering images, e.g., by identifying uniform resource locator(s) (URL) of those image(s).

The LLM response may be operable to cause a client application, such as an application that gives access to an automated assistant or chatbot that engages in human-to-computer dialogs using the LLM as a backend, to render the LLM response as a rendered LLM output that is visually appealing and/or informative. For instance, the rendered LLM output may include raw textual content from the LLM response that is rendered as set forth by metadata instructions that are also contained in the LLM response, e.g., along with images or other content identified in the metadata instructions.

As used herein, “rendered LLM output” (or simply “rendered output”) will refer generally to what is ultimately presented to the user, which may be formatted, include graphics/images/videos, etc. The user may select subportion(s) of rendered LLM output(s), issue request(s) to modify those selection(s), and be presented modified rendered LLM output(s) in which the selected subportion(s) are altered based on the user's request(s). “LLM responses” or “raw LLM responses” will refer to the sequence of tokens that are directly generated using an LLM. These tokens may include, for example, sequences of text, metadata instructions, etc., that are ultimately used to format and/or otherwise generate rendered LLM output(s).

In various implementations, the user may be able to select a subportion (i.e. less than all) of the rendered LLM output and manipulate just that selected subportion by issuing a follow up request to the LLM. For instance, if the rendered LLM output contains three paragraphs, the user may be able to select the middle paragraph and issue a variety of different types of requests to manipulate only the selected subportion, while leaving the remainder of the rendered LLM output (and underlying raw LLM response) unaltered. In the example of the user selecting a segment of textual prose (e.g., sentence(s) or paragraph(s)), these follow-up requests may include, for instance, a request that the selected text be made shorter, longer, more casual, more formal or professional, simpler, more detailed, with a different tone (e.g., funnier, more serious), rephrased (e.g., randomly, based on different beam search results, etc.), and so forth.

Other examples of ways a selection can be altered in this manner include, but are not limited to, removing the selection, adding more detail or elaborating on details contained in the selection, replacing word(s) with synonyms or other selected words or phrases, and so forth. In some implementations in which the selection states a position, theory, contention, or opinion, the user may request that additional information/text justifying and/or supporting the position, theory, contention, or opinion be added. In some implementations, the user may request that citation(s) or reference(s) be added to support purported factual statements. In other implementations in which a user has selected content rendered exclusively using metadata instructions (e.g., an image), the metadata instructions themselves may be extracted and used as pat of a subsequent LLM prompt.

Rendered LLM output often contains extra formatting information that is added based on the aforementioned metadata instructions contained in the underlying raw LLM response. For instance, HTML/XML code and/or document object model (DOM) nodes may be incorporated into (e.g., injected into, used to replace portions of) the LLM response to make it operable to be rendered by an HTML browser or other similarly configured user interface. When this occurs, in some cases, a mapping may be created that can be used later to identify portions of the raw LLM response that correspond to subportion(s) of the ultimately rendered LLM output that are selected by a user. In various implementations, when the user selects the subportion of the rendered LLM output, an indication of that subportion may be used with this mapping to extract a corresponding portion of the underlying LLM response that was used to generate the rendered LLM output. As one non-limiting example, when HTML code is incorporated into the LLM response, HTML tags may be annotated with extra attributes (e.g., character offsets) that identify where in the original LLM response the content of that HTML DOM node originates.

The indication of the subportion of the rendered LLM output that was selected by the user (e.g., starting and ending character positions) may be used to extract a portion of the original LLM response. This extracted portion may then be assembled into a follow up LLM prompt along with the user's follow up request. In some implementations, additional implied request(s) or command(s) may also be incorporated into the follow up LLM prompt that are designed to trigger selected aspects of the present disclosure. For instance, an additional implied request may be a request to “only modify the provided excerpt of the previous LLM response in accordance with the user's command. Leave the remainder of the previous LLM response unaltered.” In some implementations, the LLM may be trained and/or fine-tuned using implied requests such as these, along with LLM responses with subportions selected and corresponding user commands. This follow up LLM prompt may then be processed using the same LLM or a different LLM to generate a subsequent LLM response. The subportion of the subsequent LLM response that corresponds to the portion of the previously rendered LLM output that was selected by the user may be altered in accordance with the user's follow up request. In some implementations, the remainder of the subsequent LLM response may be left untouched, and thus may not necessarily be processed using the LLM, which conservers considerable resources.

Even though a user may wish to only alter a selected subportion of rendered LLM output, it may be the case that the changes requested by the user need to be propagated to parts of the rendered LLM output outside of the selected subportion. Suppose the rendered LLM output includes a proposed meeting agenda. Suppose further that a user selects a first date in the agenda and requests that the date be replaced with a second date that is different than the first date. If the first date is contained elsewhere in the proposed agenda outside of the portion selected by the user, failing to replace those instance(s) with the second date may yield an inconsistent meeting agenda.

Accordingly, in some implementations, the LLM may be trained and/or fine-tuned to process commands to account for discrepancies between facts or details contained inside and outside of a user's selection. For example, an explicit user follow up request to replace a first date with a second date in a selected portion of rendered LLM output (generated from an underlying LLM response) may trigger generation of an implied request to also replace the first date with the second date elsewhere in the rendered LLM output, even in portion(s) not selected by the user. This feature may be particularly useful when the LLM is used to generate complex structured language such as source code, mathematical proofs, etc. For instance, a user may select a particular code segment (e.g., a line or block) of LLM-generated source code and request that a variable name contained in the selection be altered. The same variable name may then be altered throughout the LLM-generated source code, both in the user's selection and elsewhere. In some such implementations, instances of the variable-to-be-altered that are found outside of the user's selection may be presented to the user one at a time, as a list, etc., so that the user can toggle through and approve (or reject) each proposed replacement.

As noted previously, an LLM response may include metadata instructions for rendering one or more images. Suppose a user selects a subportion of resulting rendered LLM output that includes one or more rendered images and issues a request to replace one or more of the selected rendered images with one or more alternative images. In some implementations, the user's selection of an image may be mapped to metadata instructions for retrieving the image contained in the underlying raw LLM response. In some implementations, when metadata instructions for retrieving an image are detected as corresponding to the selected portion of the rendered LLM output, a search for alternative images, e.g., using a search query formulated based on the user's accompanying request to modify the images, may be triggered automatically. For example, if the user selects an image of a tiger and requests that it be replaced with an image of a bear, that may trigger formulation and/or submission of an image search query for images of bears. Notably, only the metadata instructions may need to be modified, which may not necessarily require subsequent application of an LLM.

In some cases, the request may include a request to retrieve one or more replacement images having specified visual features. For instance, if the image is of the Eiffel Tower during the day, the user could request a replacement image that depicts the Eiffel Tower at night. Additionally or alternatively, if the request includes a natural language request to generate a modified version of one or more of the rendered images, the natural language request may be processed using a text-to-image generative model (often including both a LLM to transform input text into a latent representation, as well as a generative image model) to generate a modified version of one or more of the rendered images, or completely new images.

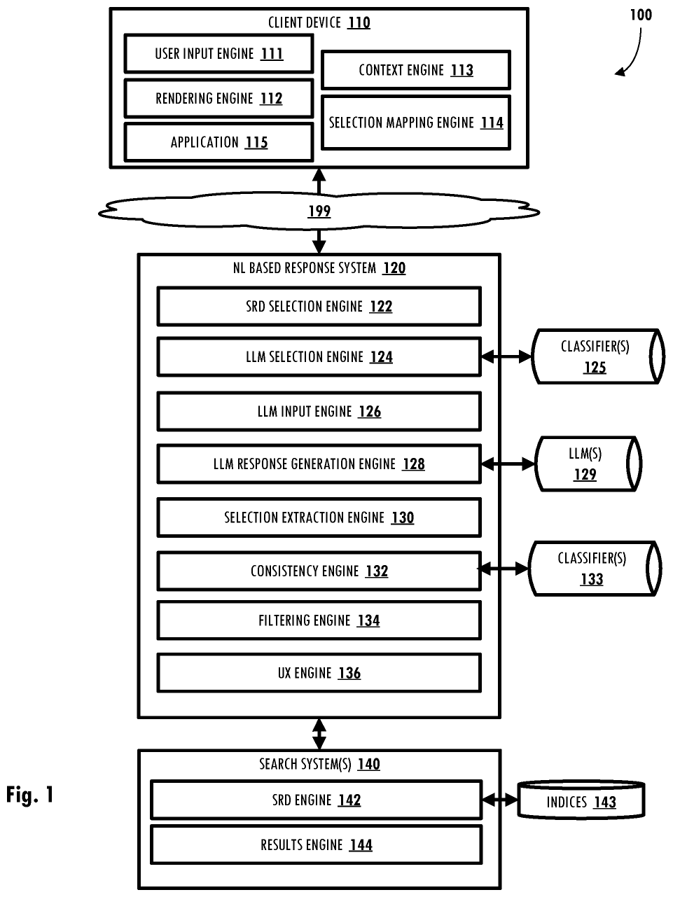

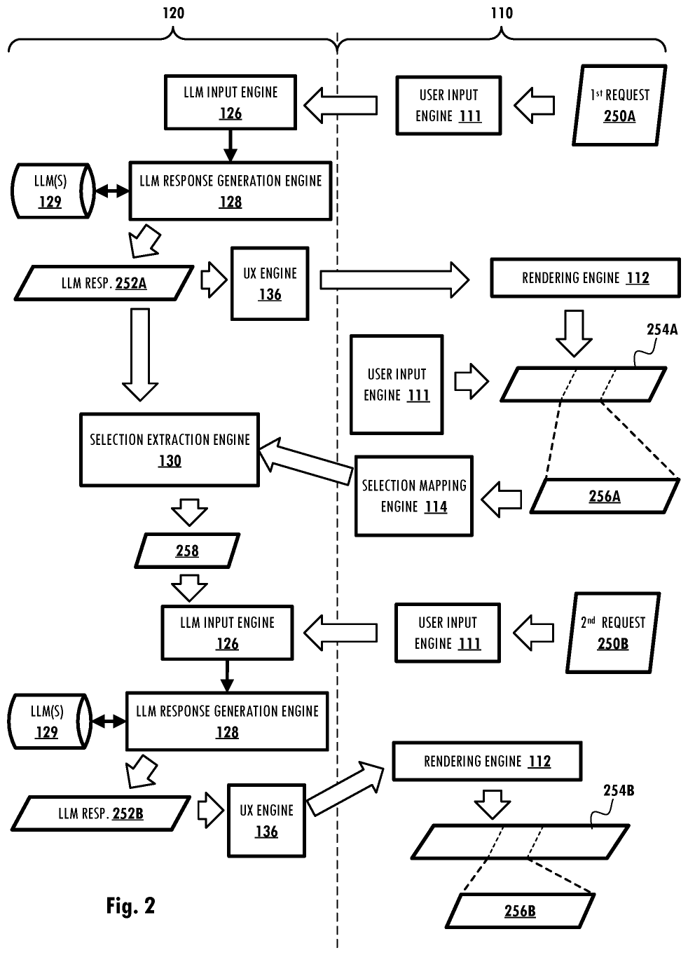

Turning now to FIG. 1, a block diagram of an example environment 100 that demonstrates various aspects of the present disclosure, and in which implementations disclosed herein can be implemented is depicted. The example environment 100 includes a client device 110, a natural language (NL) based response system 120, and search system(s) 140. Although illustrated separately, in some implementations all or aspects of NL based response system 120 and all or aspects of search system(s) 140 can be implemented as part of a cohesive system.

In some implementations, all or aspects of the NL based response system 120 can be implemented locally at the client device 110. In additional or alternative implementations, all or aspects of the NL based response system 120 can be implemented remotely from the client device 110 as depicted in FIG. 1 (e.g., at remote server(s)). In those implementations, the client device 110 and the NL based response system 120 can be communicatively coupled with each other via one or more networks 199, such as one or more wired or wireless local area networks (“LANs,” including Wi-Fi LANs, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more applications, such as application 115, via which queries can be submitted and/or NL based summaries and/or other response(s) to the query can be rendered (e.g., audibly and/or visually). The application 115 can be an application that is separate from an operating system of the client device 110 (e.g., one installed “on top” of the operating system)—or can alternatively be implemented directly by the operating system of the client device 110. For example, the application 115 can be a web browser installed on top of the operating system, or can be an application that is integrated as part of the operating system functionality. The application 115 can interact with the NL based response system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the client device 110. Some instances of a query or request described herein can be a query or request that is formulated based on user input provided by a user of the client device 110 and detected via user input engine 111. For example, the query or request can be a typed query or request that is typed via a physical or virtual keyboard, a suggested query or request that is selected via a touch screen or a mouse, a spoken voice query or request that is detected via microphone(s) of the client device, or an image query or request that is based on an image captured by a vision component of the client device.

In various implementations, the client device 110 can include a rendering engine 112 that is configured to provide content (e.g., an NL based summary, creative LLM output, chat output, etc.) for audible and/or visual presentation to a user of the client device 110 using one or more user interface output devices. For example, the client device 110 can be equipped with one or more speakers that enable content to be provided for audible presentation to the user via the client device 110. Additionally, or alternatively, the client device 110 can be equipped with a display or projector that enables content to be provided for visual presentation to the user via the client device 110. In some implementations, the display may be part of a head-mounted display (HMD).

In some implementations, rendering engine 112 may be configured to generate rendered content based on raw LLM responses. For example, an LLM response may include a sequence of tokens that is operable by rendering engine 112 to render audible and/or visual output. In some implementations, this sequence of tokens may include a sequence of raw text. Some parts of the sequence of raw text may include meaningful content that is responsive to a user's query or request. Other parts of the sequence of text may include metadata instructions (e.g., symbols) that are usable, e.g., by rendering engine 112 (or by UX engine 136, described below), to cause the meaningful content to be rendered in a particular way (e.g., with selected fonts, line breaks, images, formatting, etc.). In some implementations, rendering engine 112 may also be configured to create a mapping between raw LLM responses and the downstream rendered content that is generated based on the raw LLM responses. For instance, when incorporating raw LLM content into HTML DOM nodes, rendering engine 112 may add attributes (e.g., character offsets) to HTML tags that identify where in the underlying raw LLM response the content that is going to be displayed using the DOM node is located.

In various implementations, the client device 110 can include a context engine 113 that is configured to determine a context (e.g., current or recent context) of the client device 110 and/or of a user of the client device 110. In a multi-turn dialog session between the user and an automated assistant (alternatively, “virtual assistant”, “chatbot”, etc.), the context of the client device and/or user may be maintained over multiple turns as a “user state.”

In some implementations, the context engine 113 can determine a context and/or update the user's state utilizing current or recent interaction(s) via the client device 110, a location of the client device 110, profile data of a profile of a user of the client device 110 (e.g., an active user when multiple profiles are associated with the client device 110), and/or other data accessible to the context engine 113. For example, the context engine 113 can determine a current context based on a one or more recent queries of the search session, profile data, and/or a current location of the client device 110. For instance, the context engine 113 can determine a current context of “looking for a healthy lunch restaurant in Louisville, Kentucky” based on a recently issued query or request, profile data, and a location of the client device 110.

As another example, the context engine 113 can determine a current context based on which application is active in the foreground of the client device 110, a current or recent state of the active application, and/or content currently or recently rendered by the active application. A context determined by the context engine 113 can be utilized, for example, in supplementing or rewriting a query or request that is formulated based on user input, in generating an implied query or request (e.g., a query or request formulated independent of user input), and/or in determining to submit an implied query/request and/or to render result(s) for an implied query/request. And the user's context across multiple turns of a search session can be used as a user state to enrich output rendered, e.g., by a search chatbot companion, at each turn of a multi-turn human-to-computer dialog session.

In various implementations, client device 110 can include a selection mapping engine 114 that is configured to map user-selected subportion(s) of rendered LLM output provided by rendering engine 112 to corresponding subportion(s) of raw LLM responses that were used to generate the rendered LLM output. In some implementations, selecting mapping engine 114 may utilize the HTML attributes (e.g., character offsets) mentioned previously to map user-selected subportion(s) of rendered LLM output provided by rendering engine 112 to corresponding subportion(s) of raw LLM responses.

In various implementations, selection mapping engine 114 may provide data indicative of this mapping, such as starting and ending characters indexes in the raw LLM response, to other components to extract the corresponding portion of the raw LLM response. In some cases, selection mapping engine 114 may provide data indicative of the mapping to a component of NL based response system 120, such as selection extraction engine 130, and selection extraction engine 130 may extract the corresponding portion of the raw LLM response. In other cases, selection mapping engine 114 may use the mapping data directly to extract the corresponding portion of the raw LLM response, and provide that extracted portion to a component of NL based response system 120, such as LLM input engine 126 (discussed in more detail below).

Further, the client device 110, the NL based response system 120, and/or the search system 140 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form a coordinated ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household).

NL based response system 120 is illustrated as including a search result document (SRD) selection engine 122, an LLM selection engine 124, an LLM input engine 126, an LLM response generation engine 128, a selection extraction engine 130, a consistency engine 132, a filtering engine 134, and a user interface (UX) engine 136. Some of the engines can be omitted and/or combined in various implementations.

The SRD selection engine 122 may be configured to generate, using an LLM and search result documents that are responsive to a query, an NL based summary response to a query. SRD selection engine 122 may also cause the NL based summary to be rendered in response to the query.

The LLM selection engine 124 can, for example, select zero or more generative models from multiple candidate LLMs. For example, in some iterations the system will determine to not utilize any of the candidate generative models, in some iterations the system will determine to utilize only one of the candidate generative models, and in some iterations the system will determine to utilize multiple of the candidate generative models. LLM selection engine 124 can optionally utilize one or more rules and/or one or more classifiers 125 that are trained to generate output identifying which LLMs are best suited to generate a response to a current query or request, given a current user state/context.

The LLM input engine 126 may be configured to assemble LLM input prompts based on data such as a current query, current user state/context, past queries, past LLM responses (which may be included in the current user state/context), portions of past rendered LLM outputs that are selected by users for modification, etc. LLM input prompts may, in some implementations, include a sequence of tokens, which may be words, phrases, or embeddings generated from data such as text, images, audio, etc.

The LLM response generation engine 128 may be configured to apply one or more LLMs stored in an LLM database 129 to LLM input prompts generated by LLM input engine 126 to generate an LLM response. An LLM response may take various forms, such as a sequence of tokens that correspond to, represent, or directly convey words, phrases, embeddings, etc. LLMs stored in LLM database 129 may take a variety of form, such as PaLM, BARD, BERT, LaMDA, Meena, GPT, and/or any other LLM, such as any other LLM that is encoder-only based, decoder-only based, sequence-to-sequence based and that optionally includes an attention mechanism or other memory. Visual language models (VLMs) capable of processing images and text may be included as well.

Selection extraction engine 130 may be configured to extract subportions of raw LLM responses that correspond with selected subportions of rendered LLM output provided at client device 110 by rendering engine 112 based on the raw LLM responses. As noted previously, in some implementations, selection extraction engine 130 may extract these portions of raw LLM responses based on mapping data received from selection mapping engine 114. For example, selection mapping engine 114 may provide starting and/or ending character positions, and selection extraction engine 130 may extract the subportion of the raw LLM response that begins at the starting character position and ends at the ending character position.

Consistency engine 132 may be configured to evaluate the remainder of the raw LLM response outside of the subportion(s) extracted by selection extraction engine 130 in order maintain consistency between various aspects of the selected and unselected portions of the rendered LLM output. Suppose a user selects a middle paragraph of a scheduling email and issues the NL based request, “Please change the street number from 359 to 874.” The middle paragraph of the scheduling email (e.g., minus metadata instructions) may be extracted by selection extraction engine 130 and incorporated into a subsequent LLM input prompt by LLM input engine 126. This subsequent LLM input prompt may also include the user's request to change the street numbers. When the subsequent input request is processed by LLM response generation engine 128 using an LLM 129, the resulting LLM response may include the previous LLM response, except with the middle paragraph altered to reflect the new street numbers. However, if the street number were also included in another portion of the original rendered LLM output that the user didn't select, that other instance of the street number may not be replaced as requested, resulting in a scheduling email with inconsistent street numbers. Accordingly, in various implementations, consistency engine 132 may be configured to ensure that details changed within the selected portion of the original rendered LLM output (generated using the underlying raw LLM response) are also changed elsewhere, where applicable. In some implementations, consistency engine 132 may perform its actions heuristically, e.g., by extracting entities and facts from both the user selection and the remainder of the rendered LLM output and comparing them. In other implementations, the LLM 129 itself may be trained to maintain consistent factual details across both selected and unselected portions of LLM responses.

Updating selected subportions of rendered LLM output using LLMs can sometimes generate unpredictable results. If a user asks for more details to be provided for a given selection (e.g., a paragraph), the user may not want the resulting replacement of that selection generated using the LLM 129 to be significantly longer. Accordingly, in some implementations, filtering engine 134 may be configured to ensure that a user's request to modify a selected subportion of rendered LLM output does not result in potentially negative consequences, too many changes, etc. For instance, in some implementations, filtering engine 134 may throw an error and/or cause a warning to be issued to the user if the user's request results in a threshold number of changes (e.g., altered characters or words), or changes that are too substantial (calculated, for instance, using edit distances, word counts, etc.).

In some implementations, UX engine 136 may be configured to provide client device 110 with raw LLM responses (e.g., sequences of tokens intermixed with metadata instructions), which may be operable by rendering engine 112 to provide rendered LLM output. Additionally or alternatively, in some implementations, UX engine 136 may generate content that can be rendered more directly, such as HTML code that includes the raw LLM response and that can be rendered by rendering engine 112 or application 115, e.g., as a webpage.

Search system 140 is illustrated as including an SRD engine 142 and a results engine 144. Some of the engines can be omitted or combined with each other in various implementations. The SRD engine 142 can, for example, utilize indices 143 and/or other resources in identifying search result documents that are responsive to queries or requests as described herein. For example, SRD engine 142 can use queries or requests formulated by component(s) of NL based response system 120 to identify search result documents or other content that can be used for modifying selected subportions of rendered LLM output. For example, a user may request that evidence or other documentation be searched for and provided to support and/or refute details contained in a selected subportion of rendered LLM output. The results engine 144 can provide non-LLM generated search results that can be harvested for content to be presented along with an NL based summary described herein, and/or that may be used by LLM response generation engine 128 to generate modified LLM responses.

In some implementations, when a user issues a request to add content to a selected subportion of rendered LLM output that supports one or more details contained therein, one or more components of NL based response system 120 and/or search system 140 may formulate a search query based on the one or more details of the selected subportion of the rendered LLM output. Search system 140 may then retrieve one or more documents that are responsive to the search query. Data from the one or more documents that are responsive to the search query may be incorporated, e.g., by LLM input engine 126, into a subsequent LLM input prompt that is used to generate a modified version of the previous rendered LLM output.

FIG. 2 schematically depicts an example of how various components depicted in FIG. 1 may cooperate to carry out selected aspects of the present disclosure. As indicated at top, in some implementations, the components on the left side of the vertical dashed line may be part of NL based response system 120. Components on the right side of the vertical dashed line may be part of client device 110. In other implementations, various components may be implemented elsewhere.

Starting at top right, a first request 250A may be received at user input engine 111, which in turn provides data indicative of the first request 250A (e.g., the request itself, embedding(s) generated therefrom, etc.) to LLM input engine 126 of NL based response system 120. First request 250A may be typed, may be transcribed using ASR on a spoken utterance, or may even be an implied query. Whichever the case, data indicative of first request 250A may be assembled by LLM input engine 126 into an LLM prompt (not depicted) that is then processed by LLM response generation engine 128 using one or more LLMs from database 129 to generate a first raw LLM response 252A. As noted previously, first raw LLM response 252A may include a sequence of tokens, such as a sequence of raw text that includes both content responsive to the request and metadata instructions interspersed therein. First raw LLM response 252A may be provided by UX engine 136 to rendering engine of client device 110. Rendering engine 112 may provide, e.g., a display and/or speakers, first rendered LLM output 254A, which may include various modalities of output, such as audible, images, text, etc.

Once rendered at client device 110, the user may select, e.g., via user input engine 111, a subportion 256A of the first rendered LLM output 254A. In various implementations, the selected subportion 256A may be provided to selection mapping engine 114, which may in turn provide, to selection extraction engine 130 of NL based response system 120, data indicative of a mapping (e.g., starting and ending character positions) between the selected subportion 256A of the first rendered LLM output 254A and a corresponding subportion of first raw LLM response 252A. Selection extraction engine 130 may then use the mapping to extract a corresponding selected subportion 258 of the raw LLM response 252A.

Meanwhile, a second request 250B may be received from the user at client device, e.g., at user input engine 111. Second request 250B may include one or more commands to modify, alter, remove, etc., the selected subportion 256A. Second request 250B and selected subportion 258 of the raw LLM response 252A may be provided to LLM input engine 126, e.g., for assembly into another LLM input prompt. In some implementations, this additional LLM input prompt may also include the first request 250A.

The additional LLM input prompt may then be processed by LLM response generation engine 128 using an LLM 129 to generate a subsequent raw LLM response 252B. Subsequent raw LLM response 252B may then be provided by UX engine 136 to rendering engine 112 on client device 110. Rendering engine 112 may then generate and provide subsequent rendered LLM output 254B. Subsequent rendered LLM output 254B may include unaltered portions of original rendered LLM output 254A that were not selected by the user, as well as a modified subportion 256B in place of the selected subportion 256A of original rendered LLM output 254A. In some implementations where consistency engine 132 is deployed, the portions of original rendered LLM output 254A that are provided may also be modified if details contained therein would otherwise be inconsistent or conflict with details in the modified subportion 256B of subsequent rendered LLM output 254B.

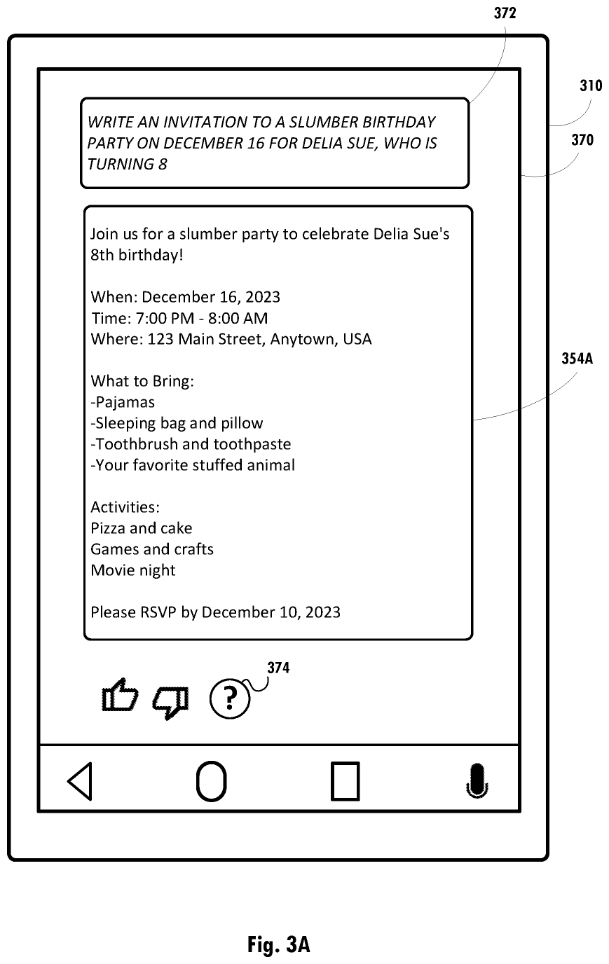

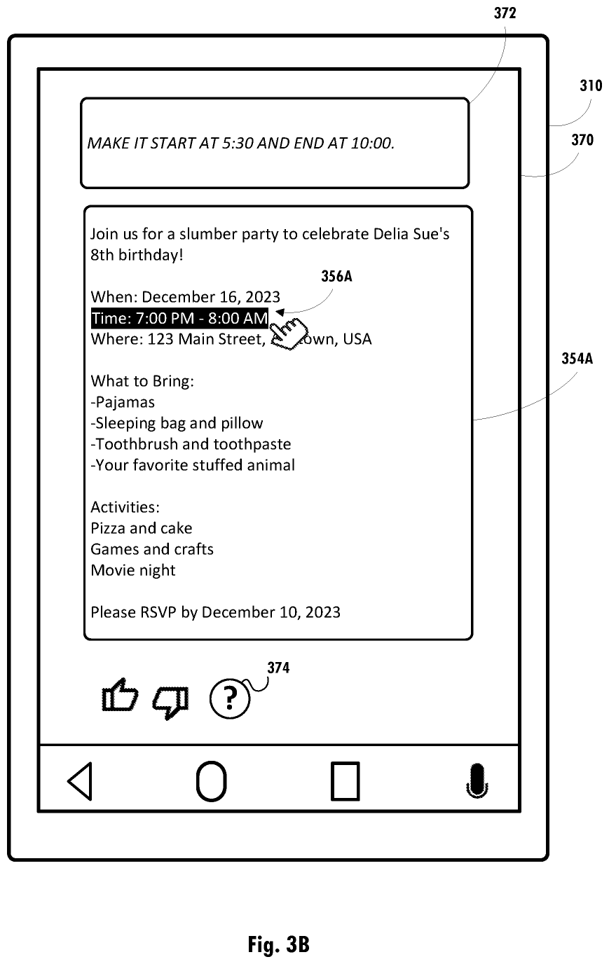

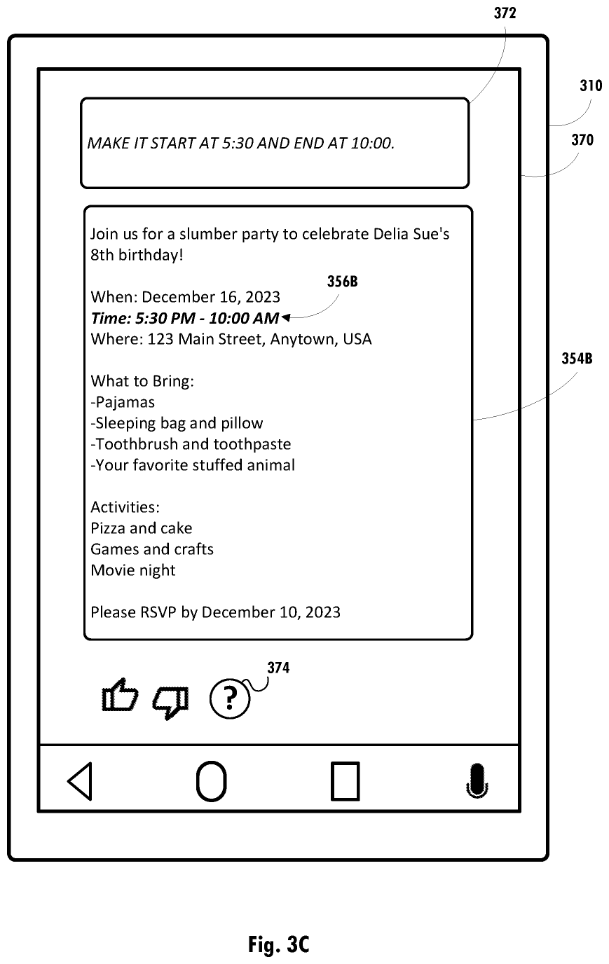

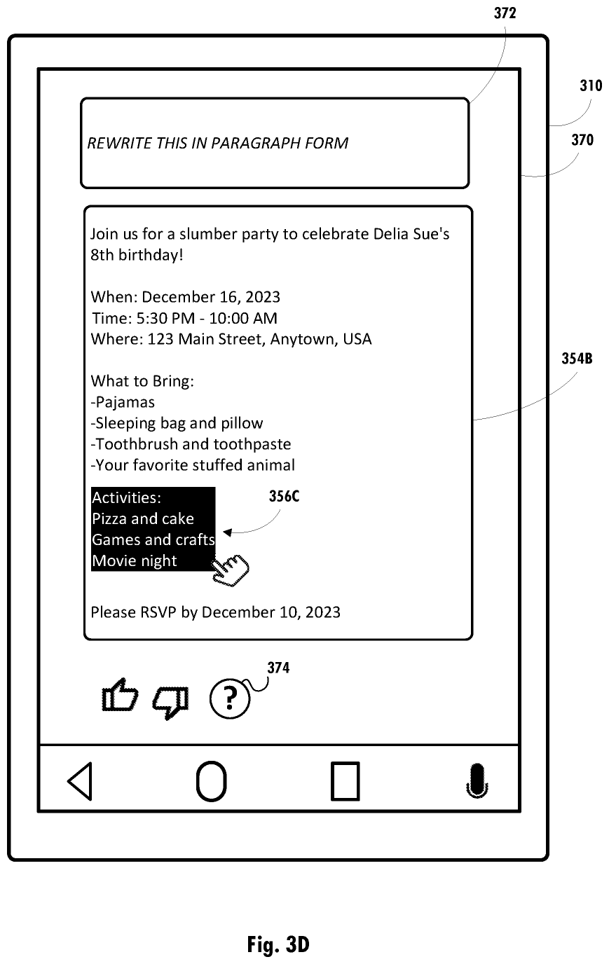

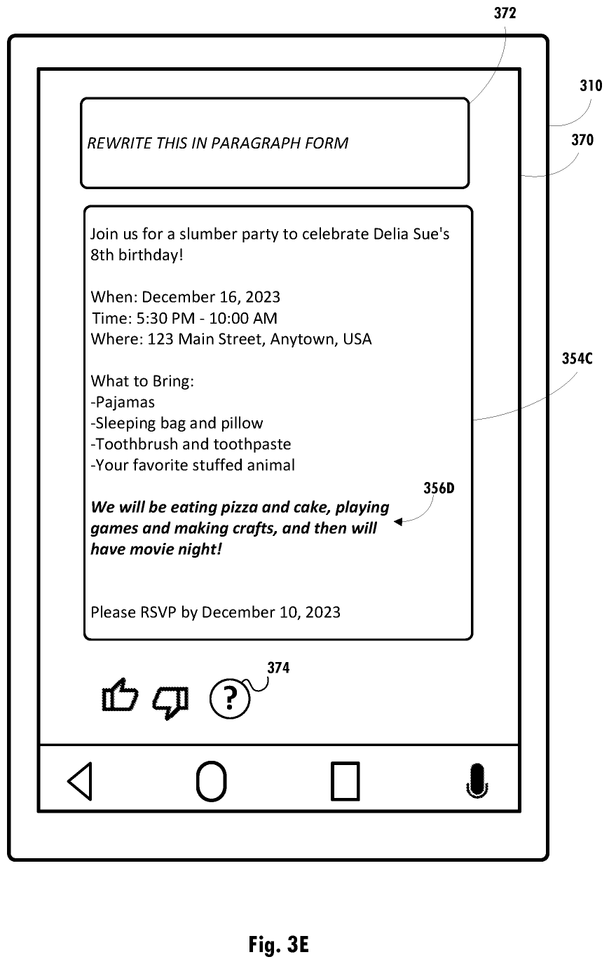

FIG. 3A depicts an example client device 310 in the form of a tablet computer that is being used to engage with NL based response system 120. Client device 310 includes a display 370 on which a query input field 372 is rendered. A user (not depicted) has entered, into query input field 372 (by typing or having a spoken utterance speech recognized), the request, “Write an invitation to a slumber birthday party on December 16 for Delia Sue, who is turning 8.” A rendered LLM output 354A that may share various characteristics with rendered LLM output 254A in FIG. 2 is generated and rendered on display 370, e.g., by rendering engine 112, based on a raw LLM response (not depicted, e.g., 252A in FIG. 2) that was generated by LLM response generation engine 128. Also rendered on display 370 are a thumbs up and down that are operable by the user to provide positive or negative feedback, respectively, about rendered LLM output 354A, as well as an optional graphical element 374 that the user can select to initiate selected aspects of the present disclosure. In particular, the user may operate element 374 in order to initiate the process depicted in FIG. 2.

As noted previously, in some implementations, rendered LLM output 354A may be provided within an editable text field or other similar interface. This may allow the user to edit rendered LLM output 354A (and other rendered LLM outputs described herein) directly, instead of requiring the user to copy and paste rendered LLM output 354A into a text editor, word processor, or other application that allows the user to edit content. In some such implementations, user edits to rendered LLM outputs may be annotated, e.g., using different font, color, etc., so that the user is able to keep track of which portions of the rendered LLM output are original and which have been edited by the user. In some implementations, edited versions of rendered LLM outputs may be preserved as part of saved threads, e.g., so that they can be used to generate downstream input prompts. In some implementations, an edited portion of a rendered LLM response may then be selected by a user as a subportion and processed using an LLM to generate a modified LLM response. For instance, a user could manually edit a rendered LLM output to change a detail (e.g., a date, address, etc.), and then select the subportion of the rendered LLM output that includes the changed detail and request additional modification(s) (e.g., make is shorter, longer, funnier, etc.). The edited subportion of the rendered LLM response could then be assembled into a subsequent input prompt and processed as described herein.

In FIG. 3B, the user has selected a subportion 356A (which may correspond to selected subportion 256A in FIG. 2) of rendered LLM output 354A and provided, in query input field 372, the follow up request, “Make it start at 5:30 and end at 10:00.” Consequently, in FIG. 3C, a subsequent rendered LLM output 354B that includes a modified subportion 356B (which may correspond to modified subportion 256B in FIG. 2) has been used to replace the selected subportion 356A. As requested, the modified subportion 356B indicates that the party starts at 5:30 PM and ends at 10:00 AM the next day.

In the example of FIGS. 3A-C, the user need not necessarily have selected the subportion 256A. Instead, the user could have issued the same command to change the start and end times, and the entire rendered LLM output 354A could have been reprocessed by LLM response generation engine 128 to obtain the same subsequent rendered LLM output 354B depicted in FIG. 3C. However, only processing the selected subportion 356A, rather than the entire rendered LLM output 354B, may consume considerably fewer computing resources, as LLMs typically include hundreds of millions, if not billions, of parameters. With myriad client computing devices interacting with NL based response system 120 during any time interval, conserving resources in this way may dramatically reduce latency, as well as conserve power.

In FIG. 3D, the user has selected a subportion 356C of the subsequent rendered LLM output 354B that identifies a list of activities that are planned for the birthday party. The user has provided, in query input field 372, the request, “Rewrite this in paragraph form.” Consequently, in FIG. 3E, another subsequent rendered LLM output 354C that includes a modified subportion 356D has been used to replace the selected subportion 356C. As requested, the modified subportion 356D describes, in paragraph form, the activities planned for the party.

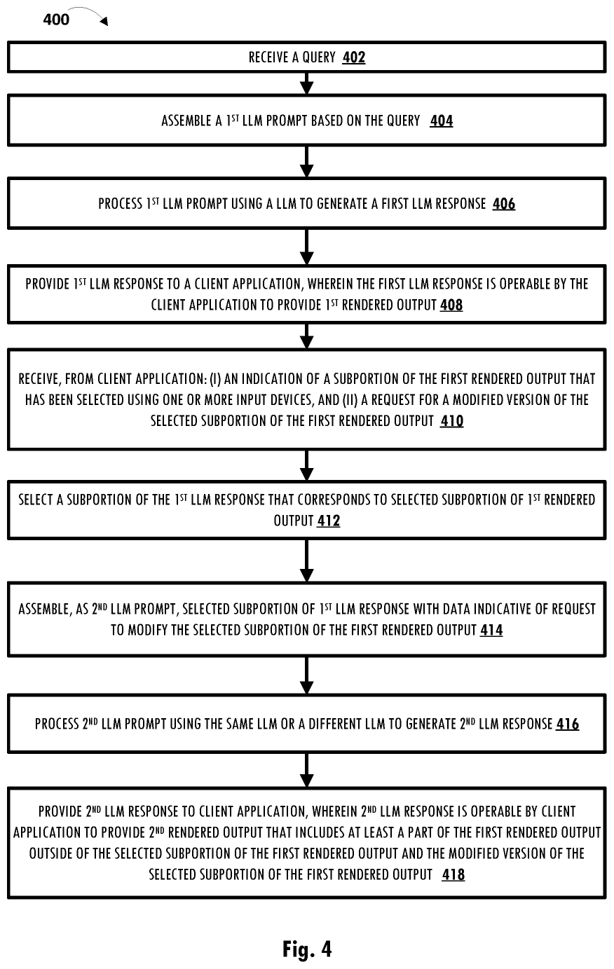

Turning now to FIG. 4, a flowchart is depicted that illustrates an example method 400 of implementing selected aspects of the present disclosure. For convenience, the operations of the method 400 are described with reference to a system that performs the operations. This system of the method 400 includes one or more processors, memory, and/or other component(s) of computing device(s). Moreover, while operations of the method 400 are shown in a particular order, this is not meant to be limiting. One or more operations may be reordered, omitted, and/or added.

At block 402, the system may receive a query or request. For example, a user may speak or type a natural language request that is processed by user input engine 111 and provided to UX engine 136 and/or LLM input engine 126. At block 404, the system, e.g., by way of LLM input engine 126, may assemble a first LLM prompt based on the query.

At block 406, the system, e.g., by way of LLM response generation engine 128, may process the first LLM prompt using an LLM (e.g., 129) to generate a first (raw) LLM response (e.g., 252A in FIG. 2). As noted elsewhere herein, first LLM response (and other “raw” LLM responses described herein) may include a sequence of tokens, such as a sequence of raw text intermixed with metadata instructions in some cases. Metadata instructions may include formatting instructions (e.g., identified fonts, line breaks, indents, spacing, etc.), as well as instructions for rendering other modalities of data, such as images, videos, audio, graphics, etc.

At block 408, the system, e.g., by way of UX engine 136, may provide the first LLM response to a client application, such as application 115, rendering engine 112, etc. In various implementations, the first LLM response may be operable by the client application to provide first rendered LLM output (e.g., 254A in FIG. 2). For instance, rendering engine 112 may be configured to process the first LLM response to generate a HTML DOM hierarchy that causes the relevant content contained in the first LLM response to be rendered, e.g., by application 115, in a useful way.

At block 410, the system, e.g., by way of selection extraction engine 130, may receive, from the client application, (i) an indication of a subportion (e.g., 256A in FIG. 2) of the first rendered LLM output (e.g., 254A in FIG. 2) that has been selected using one or more input devices, and (ii) a request (e.g., 250B in FIG. 2) for a modified version of the selected subportion of the first rendered LLM output. The indication of the subportion (e.g., 256A) of the first rendered LLM output (e.g., 254A) that has been selected may include, for instance, start and end character positions, or another type of mapping between the selected subportion (e.g., 256A) of the first rendered LLM output and a corresponding subportion of the first raw LLM response (e.g., 252A) generated at block 406.

At block 412, the system, e.g., by way of selection extraction engine 130, may extract or select a subportion (e.g., 258 in FIG. 2) of the first LLM response that corresponds to the selected subportion (e.g., 256A) of the first rendered LLM output (e.g., 254A), e.g., based on the indication received at block 410. At block 414, the system, e.g., by way of LLM input engine 126, may assemble, as a second LLM prompt, the selected subportion (e.g., 258) of the first LLM response (e.g., 252A) with data indicative of the request (e.g., 250B) to modify the selected subportion (258) of the first rendered LLM output. In some implementations, LLM input engine 126 may also include one or more implied requests, such as for consistency engine 132 to evaluate the various portions to ensure consistency between details and/or facts, and/or for the prior LLM response (e.g., 252A) outside of the selected portion (258) to be passed through, so that it can be included in the downstream LLM response (e.g., 252B in FIG. 2).

At block 416, the system, e.g., by way of LLM response generation engine 128, may process the second LLM prompt using the same LLM (e.g., 129) or a different LLM to generate a second LLM response (e.g., 252B in FIG. 2). At block 418, the system, e.g., by way of UX engine 136, may provide the second LLM response (e.g., 252B) to the client application. In various implementations, the second LLM response may be operable by the client application, e.g., via rendering engine 112, to provide second rendered LLM output (e.g., 254A in FIG. 2) that includes at least a part of the first rendered LLM output outside of the selected subportion of the first rendered LLM output and the modified version (e.g., 256B) of the selected subportion (e.g., 256A) of the first rendered LLM output (e.g., 254A).

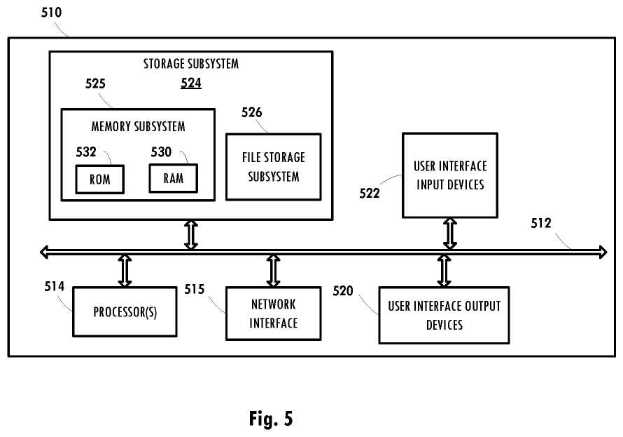

Turning now to FIG. 5, a block diagram of an example computing device 510 that may optionally be utilized to perform one or more aspects of techniques described herein is depicted. In some implementations, one or more of a client device, cloud-based automated assistant component(s), and/or other component(s) may comprise one or more components of the example computing device 510.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the methods disclosed herein, as well as to implement various components depicted in FIG. 1 or 2.

These software modules are generally executed by processor 514 alone or in combination with other processors. Memory 525 used in the storage subsystem 524 can include a number of memories including a main random access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514. Bus subsystem 512 provides a mechanism for letting the various components and subsystems of computing device 510 communicate with each other as intended. Although bus subsystem 512 is shown schematically as a single bus, alternative implementations of the bus subsystem 512 may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In situations in which the systems described herein collect or otherwise monitor personal information about users, or may make use of personal and/or monitored information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be altered before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that the user's particular geographic location cannot be determined. Thus, the user may have control over how information is collected about the user and/or used.

What is claimed is:

1. A method implemented using one or more processors, comprising:
processing a first large language model (LLM) prompt using an LLM to generate a first LLM response;
providing the first LLM response to a client application, wherein the first LLM response is operable by the client application to provide first rendered LLM output;
receiving, from the client application:
an indication of a subportion of the first rendered LLM output that has been selected using one or more input devices, and
a request for a modified version of the selected subportion of the first rendered LLM output;
extracting a subportion of the first LLM response that corresponds to the selected subportion of the first rendered LLM output;
assembling, as a second LLM prompt, the selected subportion of the first LLM response with data indicative of the request to modify the selected subportion of the first rendered LLM output;
processing the second LLM prompt using the same LLM or a different LLM to generate a second LLM response; and
providing the second LLM response to the client application, wherein the second LLM response is operable by the client application to provide second rendered LLM output that includes at least a part of the first rendered LLM output outside of the selected subportion of the first rendered LLM output and the modified version of the selected subportion of the first rendered LLM output.

2. The method of claim 1, wherein the first LLM response comprises a string of raw text that includes metadata instructions for formatting the first rendered LLM output at the client application.

3. The method of claim 2, wherein the selecting comprises receiving, from the client application, a starting character position and an ending character position that identify a segment of the string of raw text outside of the metadata instructions.

4. The method of claim 1, wherein the request for a modified version of the selected subportion of the first rendered LLM output comprises a request to add one or more details to the selected subportion of the first rendered LLM output.

5. The method of claim 1, wherein the request for a modified version of the selected subportion of the first rendered LLM output comprises a request to modify or replace one or more details of the selected subportion of the first rendered LLM output.

6. The method of claim 1, wherein the request for a modified version of the selected subportion of the first rendered LLM output comprises a request to add content to the selected subportion of the first rendered LLM output that supports one or more details of the selected subportion of the first rendered LLM output.

7. The method of claim 6, further comprising:
formulating a search query based on the one or more details of the selected subportion of the first rendered LLM output;
retrieving, from a search engine, one or more documents that are responsive to the search query; and
incorporating data from the one or more documents that are responsive to the search query into the second LLM prompt.

8. The method of claim 1, wherein the request for a modified version of the selected subportion of the first rendered LLM output comprises a natural language request.

9. The method of claim 1, wherein the first LLM response comprises metadata instructions for rendering one or more images, and the selected subportion of the first rendered LLM output comprises one or more rendered images.

10. The method of claim 9, wherein the request for a modified version of the selected subportion of the first rendered LLM output comprises a request to replace one or more of the rendered images with one or more alternative images.

11. The method of claim 10, wherein the request to replace one or more of the rendered images with one or more alternative images comprises a natural language request to retrieve one or more replacement images having specified visual features.

12. The method of claim 9, wherein the request for a modified version of the selected subportion of the first rendered LLM output comprises a natural language request to generate a modified version of one or more of the rendered images, and processing the second LLM prompt using the same LLM or a different LLM comprises processing the natural language request using a text-to-image generative model to generate the modified version of one or more of the rendered images.

13. A system comprising one or more processors and memory storing instructions that, in response to execution by the one or more processors, cause the one or more processors to:
process a first large language model (LLM) prompt using an LLM to generate a first LLM response;
provide the first LLM response to a client application, wherein the first LLM response is operable by the client application to provide first rendered LLM output;
receive, from the client application:
an indication of a subportion of the first rendered LLM output that has been selected using one or more input devices, and
a request for a modified version of the selected subportion of the first rendered LLM output;
select a subportion of the first LLM response that corresponds to the selected subportion of the first rendered LLM output;
assemble, as a second LLM prompt, the selected subportion of the first LLM response with data indicative of the request to modify the selected subportion of the first rendered LLM output;
process the second LLM prompt using the same LLM or a different LLM to generate a second LLM response; and
provide the second LLM response to the client application, wherein the second LLM response is operable by the client application to provide second rendered LLM output that includes at least a part of the first rendered LLM output outside of the selected subportion of the first rendered LLM output and the modified version of the selected subportion of the first rendered LLM output.

14. The system of claim 13, wherein the first LLM response comprises a string of raw text that includes metadata instructions for formatting the first rendered LLM output at the client application.

15. The system of claim 14, wherein the instructions to extract comprise instructions to receive, from the client application, a starting character position and an ending character position that identify a segment of the string of raw text outside of the metadata instructions.

16. The system of claim 13, wherein the request for a modified version of the selected subportion of the first rendered LLM output comprises a request to add one or more details to the selected subportion of the first rendered LLM output.

17. The system of claim 13, wherein the request for a modified version of the selected subportion of the first rendered LLM output comprises a request to modify or replace one or more details of the selected subportion of the first rendered LLM output.

18. The system of claim 13, wherein the request for a modified version of the selected subportion of the first rendered LLM output comprises a request to add content to the selected subportion of the first rendered LLM output that supports one or more details of the selected subportion of the first rendered LLM output.

19. The system of claim 18, further comprising instructions to:
formulate a search query based on the one or more details of the selected subportion of the first rendered LLM output;
retrieve, from a search engine, one or more documents that are responsive to the search query; and
incorporate data from the one or more documents that are responsive to the search query into the second LLM prompt.

20. At least one non-transitory computer-readable medium comprising instructions that, in response to execution by one or more processors, cause the one or more processors to:
process a first large language model (LLM) prompt using an LLM to generate a first LLM response;
provide the first LLM response to a client application, wherein the first LLM response is operable by the client application to provide first rendered LLM output;
receive, from the client application:
an indication of a subportion of the first rendered LLM output that has been selected using one or more input devices, and
a request for a modified version of the selected subportion of the first rendered LLM output;
select a subportion of the first LLM response that corresponds to the selected subportion of the first rendered LLM output;
assemble, as a second LLM prompt, the selected subportion of the first LLM response with data indicative of the request to modify the selected subportion of the first rendered LLM output;
process the second LLM prompt using the same LLM or a different LLM to generate a second LLM response; and
provide the second LLM response to the client application, wherein the second LLM response is operable by the client application to provide second rendered LLM output that includes at least a part of the first rendered LLM output outside of the selected subportion of the first rendered LLM output and the modified version of the selected subportion of the first rendered LLM output.
